(19) United States
(12) Patent Application Publication
(10) Pub. No.: US 2010/0037414 A1
(43) Pub. Date: Feb. 18, 2010

(54) Tools for filling holes in a surface

(76) Inventor: Konstantinos Dimos, Newburyport, MA (US)

Correspondence Address: GORDON E NELSON;PATENT ATTORNEY, PC, 57 CENTRAL ST, PO BOX 782, ROWLEY, MA, 01969, US

(21) Appl. No.: 12/500,139

(22) Filed: Jul. 9, 2009

Related U.S. Application Data
(60) Provisional application No. 61/079,164, filed on Jul. 9, 2008.

(51) Int. Cl. B05C 17/10; B65D 85/00

(52) U.S. Cl. 15/245.1; 30/298; 206/229

(57) ABSTRACT

Tools for filling holes and preparing surfaces for painting. A finger putty knife that fits on a fingertip. The putty knife's working surface is held on the fingertip by a cylindrical band. The working surface is used to force putty into a hole and remove excess putty. The finger putty knife does not hinder the motion of the finger or other fingers and engages the fleshy part of the fingertip so that the working surface flexes while working the putty and does not come off the finger. A tool container with an attachment clip for attaching the container to the user's clothing, for holding soft putty, a razor and a putty knife. The tools can be accessed with one hand

### CROSS-REFERENCE TO RELATED APPLICATIONS

The subject matter of this patent application is related to and claims priority from U.S. Provisional Patent Application 61/079164, Dimos, Painter's Tools, filed 9 Jul. 2008, which is hereby incorporated by reference in its entirety:

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

This invention relates to tools for applying viscous material to fill holes in a surface, and in particular to tools for filling holes in a surface prior to painting the surface.

2. Description of Related Art

A common need in preparing surfaces for painting is to fill holes in the surface to make the overall surface level and paintable. Preparing the surface prior to applying paint has been a substantial part of the overall task of painting the surface.

The general process of filling a hole in a surface is as follows:
Place an amount of a filler material, such as putty, on the hole.
Press the filler material into the hole.
Level and flatten the filler material so that it fills the hole and the top surface of the filler material in the hole is even with the surface.
Remove any excess filler material from the surface around the hole.

The tool generally used to perform the last three steps in one press/level/remove motion is a putty knife.

Modern filler materials include materials that do not shrink and can be painted immediately after the hole has been filled. An example is Dalp® 33® Glazing Compound, available from DAP Products Incorporated, 2400 Boston Street, Suite 200, Baltimore Md. 21223. A problem resulting from these modern filler materials is that because filling and painting can be done in a single pass, a modern painter needs to have his or her filler material and putty knife with him or her at all times. Unfortunately, standard putty knives and material holders still have forms from the time when puttying and painting were necessarily done in separate passes. What is needed is puttying tools and material holders that a painter can easily carry with him or her and use while he or she is painting and thus avoid the need to come down off the ladder or scaffold for the puttying tools when the painter discovers a hole that needs to be filled in the surface he or she is painting. It is an object of the invention disclosed herein to provide such tools.

### BRIEF SUMMARY OF THE INVENTION

In one aspect, an object of the invention is achieved by a tool for filling a hole in a surface. The tool is often referred to in the following as a “finger putty knife”. The tool has a working surface for forcing filler material into a hole in a surface and removing filler material remaining on the surface with the hole. The working surface is attached to the fingertip by an attacher. Example attachers are bands that encircle the fingertip or sheaths into which the fingertip fits.

In further aspects of the invention, the tool does not hinder the motion of the fingertip, the working surface interacts resiliently with the fleshy part of the fingertip, and the working surface is composed of a material suitable for working the filler material.

In another aspect of the invention, the attacher defines a cylindrical form, which may be rigid or flexible, with an open end. The tool is attached to the finger by inserting the end of the fingertip into the open end.

In additional aspects of the invention, the working surface is affixed to the rigid cylindrical form. The working surface is towards the tip of the fingertip with respect to the form. The working surface is also angled towards the fingertip. The angle between the working surface and the rigid cylindrical form causes the tool to engage the fleshy part of the fingertip, which prevents the tool from coming off the finger when in use. The rigid cylindrical form may further include an opening that allows the diameter of the form to adjust for comfort and/or fit on the finger.

Further aspects of the invention include that the working surface has a filling portion and a scraping portion. The filling portion forces the viscous substance into the hole. The shape of the filling portion conforms to the surface with the hole. The scraping portion has an edge at or near the tip of the finger and is used to remove excess amounts of the viscous substance. The shape of the edge conforms to the surface with the hole. The working surface may further be part of the surface of the attacher.

Yet another aspect of the invention is that the scraping portion's edge is formed according to whether the tool is to be used on a finger of the right or left hand. The corner of the edge towards the thumb of the hand is higher than the corner of the edge opposite the thumb.

Other aspects of the invention are shown in an apparatus for holding tools and material employed in preparing a surface for painting. This apparatus is often referred to in this context as a “putty buddy”. The putty buddy has a container for holding material such as a viscous or soft filler material. The container has a number of sides. The apparatus has an attacher on one of the sides for attaching the apparatus to an article of work clothing, and holders for a razor and a knife on other side or sides. The apparatus allows a user to access with one hand the razor, the knife, and/or the material. The apparatus includes one or more guard protrusions that prevent the holders from catching on other objects.

Upon perusal of the Detailed Description and drawing below, other objects and advantages will be apparent to those skilled in the arts to which the invention pertains.

### BRIEF DESCRIPTION OF THE SEVERAL VIEWS OF THE DRAWINGS

FIG. 1 shows a presently-preferred embodiment of a hole-filling tool according to the principles of the invention.

FIG. 2 illustrates the use of the hole-filling tool.

FIG. 3 shows a first view of a tool container designed for use during surface preparation.

FIG. 4 shows additional views of the tool container.

FIG. 5 shows views of a second embodiment of a hole-filling tool according to principles of the invention.

FIG. 6 shows a view of a presently-preferred embodiment of the tool container.

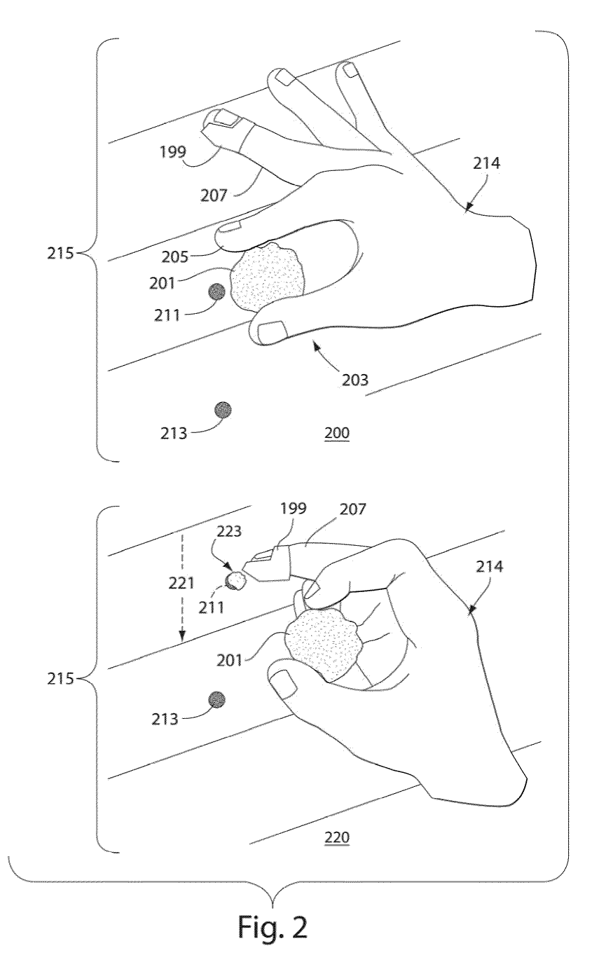

Reference numbers in the drawings have three or more digits: the two right-hand digits are reference numbers in the drawing indicated by the remaining digits. Thus, an item with the reference number 203 first appears as item 203 in FIG. 2.

### DETAILED DESCRIPTION OF THE INVENTION

The following Detailed Description of the invention discloses embodiments of a hole-filling tool and a tool container that embody the principles of the present invention. In the present context, the hole filling tool is referred to as a “finger putty knife”, the tool container is referred to as a “putty buddy”, “putty” refers to any viscous filler material and “working surface” refers to a surface that works the filler material.

Finger Putty Knife

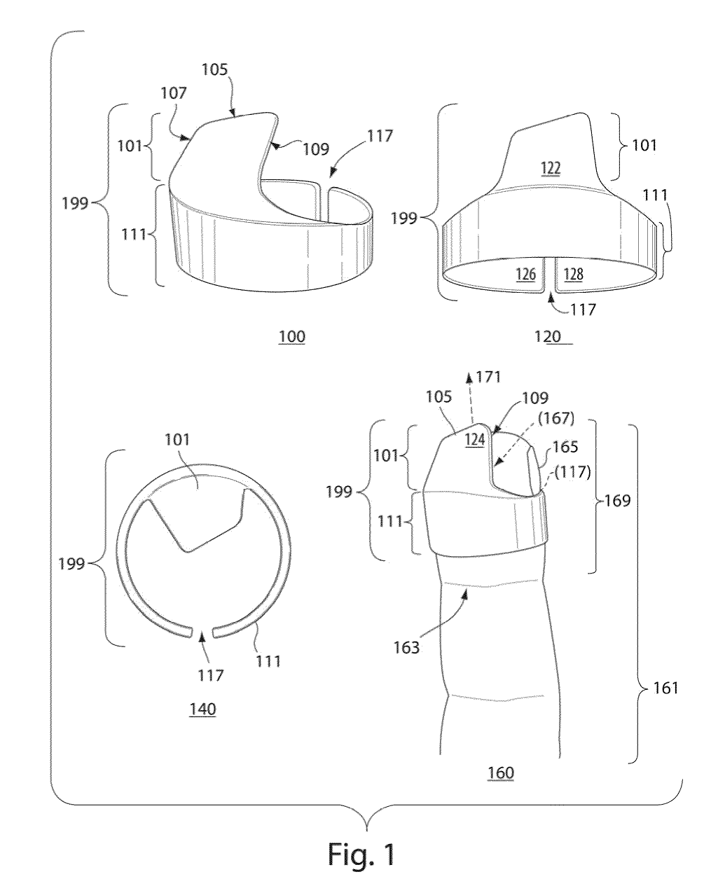

FIG. 1 shows views of a presently-preferred embodiment of the finger putty knife.

View 160 shows presently-preferred embodiment 199 of the finger putty knife worn on a finger 161. Working surface 101 is attached to finger 161 by band 111: working surface 101 is shown affixed to band 111 by being of a single piece with band 111. Working surface 101 is backed by and interacts with fleshy part 167 (not visible) of finger 161 on the side opposite fingernail 165. Embodiment 199 is worn above tip joint 163 of finger 161, and thus does not hinder motion of fingertip 169. Direction 171 illustrates the forward direction along the axis of the tip of finger 161.

Turning to view 120, working surface 101 has a filling portion 122, indicated by shading, for forcing putty into the hole and leveling the top of the putty with the surface with the hole. The shape of working surface 101 conforms to the surface with the hole to be filled. Embodiment 199 is for filling a hole in a flat surface, and working surface 101 is correspondingly flat. Working surface 101 also has a scraping portion 124 including edge 105 (in view 160).

Returning to view 160, working surface 101 has an edge 105 disposed at the tip end of finger 161. Working edge 105 is part of scraping portion 124 of working surface 101, and is shaped to match the surface with the hole to be filled, for removing excess putty from the surface. Embodiment 199 is for filling holes in a flat surface: working edge 105 is correspondingly straight. In the presently-preferred embodiment, the angle of edge 105 relative to working surface 101 is determined by whether embodiment 199 is for the left or right hand. Edge 105 is angled such that the highest corner of working surface 101 along is on the side of working surface 101 towards the thumb of the hand of finger 161.

Working surface 101 further has two side edges 107 and 109. As shown at edges 107 and 109 of preferred embodiment 199, the working surface tapers towards working edge 105.

Band 111 encircles fingertip 169. In preferred embodiment 199, band 111 has a compressible/expandable opening in the form of slot 117 (not visible in view 160) disposed opposite working surface 101. Slot 117 permits the diameter of band 111 to vary and thus allows band 111 to be adjusted for fit and/or to flex to change its size as the shape of the fleshy part of the fingertip changes during use of preferred embodiment 199.

Oblique view 100 of embodiment 199 shows slot 117 on band 111, band 111 of embodiment 199 defining a cylindrical form. Working surface 101, side edges 107 and 109, and working edge 105 are also visible.

Front view 120 of embodiment 199 shows working surface 101 of embodiment 199, band 111, and slot 117. In embodiment 199, slot 117 extends completely through band 111, thus forming two ends 126 and 128 of band 111. In embodiment 199, ends 126 and 128 may be spread apart, pressed together, or overlapped to vary the circumference of the band.

Top view 140 shows a top view of embodiment 199. Views 140 and 100 show working surface 101 angled towards finger 161. Slot 117 is visible as being on the opposite side of band 111 from working surface 101. The angle of working surface 101 relative to band 111 causes preferred embodiment 199 to engage fleshy part 167 of fingertip 169, and thus prevents embodiment 199 from coming off finger 161 in use. Fleshy part 167 of fingertip 169 further provides a resilient backing for working surface 101.

FIG. 2 illustrates how preferred embodiment 199 is used to fill a hole in a surface 200 shows the application of an amount of putty onto hole 211 on surface 215 to be painted. Two nail holes to be filled in surface 215 are shown at 211 and 213.

Preferred embodiment 199 may be worn on any finger of hand 214, such as on middle finger 207. A small mass of putty 201 is held between thumb 203 and forefinger 205. Mass 201 is pressed onto hole 211, and with a sideways motion of hand 217, an amount of putty (shown at 223 in view 220) is broken off and remains on hole 211.

220 illustrates how the combined operations of pressing/leveling/removing are performed easily in a single motion of finger 207 of hand 214. Working surface 101 (not indicated) of finger putty knife 199 is drawn over hole 211 (not visible) by finger 207 in a downward motion, as indicated at 221. In this motion,
working surface 101 forces putty 223 into the hole.
working surface 101 makes putty 223 level and even with the top of hole 211 (not visible) and with surface 215, and
working surface 101 and edge 105 remove excess putty from surface 215 near hole 211 in a scraping or wiping action.

If excess putty still remains on the surface, it may be removed immediately with a second scraping motion. Putty accruing to the tool may be cleaned from working surface 101 by simply pressing the fingertip with embodiment 199 against the palm of hand 217 and dragging embodiment 199 across the palm with finger 207.

Principles of the invention exemplified by the foregoing presently-preferred embodiment include the following:
The relationship between the working surface and the fingertip is such that the working surface moves with the fingertip and its orientation relative to the fingertip does not change.
The working surface interacts with the fleshy part of the fingertip. The interactions include:
   The elasticity of the fleshy part of the fingertip gives the working surface resilience like that of a putty knife with regard to irregularities in the surface in which the holes are being filled.
   As illustrated in the preferred embodiment, the working surface and the attachment to the fingertip interacts with the fleshy part of the fingertip to prevent substantial change in the orientation of the working surface with respect to the fingertip during use.
The finger putty knife does not hinder the motion of the fingertip, and does not hinder the use of other fingers.
The working surface may be made from any material suitable for working a particular kind of putty in the fashion described, for example the metal of the preferred embodiment, or a stiff or inelastic plastic, for putties with characteristics similar to the exemplary glazing compounds cited.
The shape of the filling portion conforms to the surface being worked.
The shape of the scraping portion conforms to the surface being worked.
Any mode of attachment to the fingertip may be used which permits the working surface to move with the fingertip without change of the working surface's orientation relative to the fingertip. Modes of attachment that do not hinder the motion of the fingertip and/or that permit the working surface to interact with the fleshy part of the fingertip are particularly advantageous. Modes of attachment according to the principles of the invention include:
   the working surface may be affixed to or be part of the surface of a rigid cylindrical form that fits on a fingertip, or
   the working surface may be affixed to a flexible cylindrical form that fits over the finger, or
   the working surface may be affixed to a fingertip by adhesive.

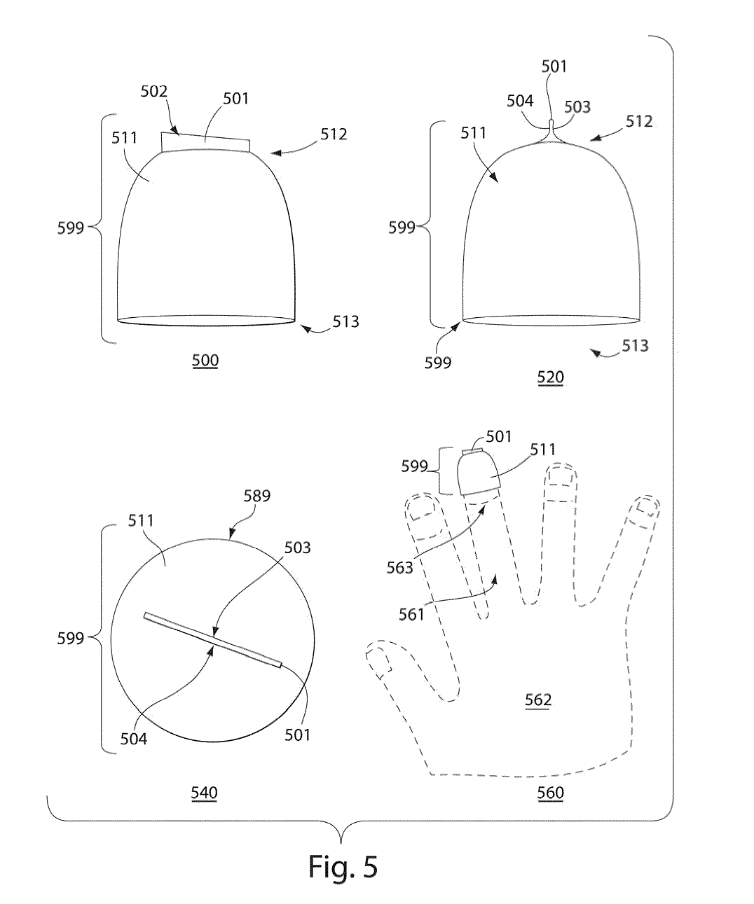

FIG. 5 shows a second embodiment 599 of the finger putty knife in which the working surface is attached to the finger by a thimble. View 560 shows second embodiment 599 on a finger 561 of hand 562: working surface 501 is attached to finger 561 by thimble 511 with closed end 512 (in view 500) and open end 513 (in view 500). Working surface 501 and working edge 502 (in view 500) shown in this example are appropriate to filling holes in a flat surface. When embodiment 599 is placed on finger 561 for use, edge 502 is roughly parallel to the plane of the hand. The angle of working edge 502 may be varied, such as for more comfortable use for the right or left hand. Working surface 501 is disposed at the center of closed end 512 of thimble 511: this disposition may also be offset, such as to be towards the fleshy side of the fingertip. Working surface 501 interacts resiliently with the fleshy portion of the tip of finger 561 by means of thimble 511.

Oblique view 500 shows thimble 511 and working surface 501 with working edge 502. Also visible are closed end 512 and open end 513 of thimble 511.

Side view 520 shows working surface 501, thimble 511, and two sides 503 and 504 of working surface 501, viewed from a direction extended along working edge 502 of working surface 501. Also shown are closed end 512 and open end 513.

End view 540 of embodiment 599 shows working surface 501 with sides 503 and 504, and thimble 511, viewed from a direction extended from closed end 512 of thimble 511. As is visible in view 540, thimble 511's cross-sectional shape is preferentially slightly elliptical, the shape chosen in the case of embodiment 599 to maintain the orientation of working surface 501 with respect to finger 562 during use, and to engage the fleshy part of the fingertip of finger 562 so that the finger putty knife is prevented from coming off finger 561. Thimble 511 preferentially has a tapered diameter along its length.

In other possible embodiments, thimble 511 may be modified so that some or all of working surface 501 is part of thimble 511: working surface 501 need not be separate from thimble 511.

Embodiment 599 is used in a similar fashion to that described for FIG. 2. The embodiments shown in FIG. 1 and FIG. 5 are exemplary and many other embodiments that incorporate the principles of the finger putty knife are possible.

Putty Buddy

During painting, it may not only be necessary to fill holes not already filled, but to also perform other surface preparation operations or to remove dried paint drips from glass. Such tasks require the use of appropriate tools and materials, and these need to be easily available to the painter for the same reasons that a putty knife needs to be easily available.

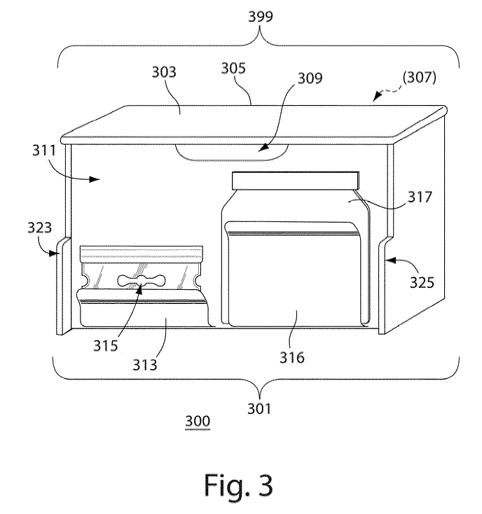

FIG. 3 and FIG. 4 and FIG. 6 show embodiments of the putty buddy. In this context, “pocket” refers to a holder portion for holding a tool.

Oblique view 300 in FIG. 3 shows a first embodiment 399 of the putty buddy. Container 301 for putty has a lid 303: lid 303 has lip extension 309 for ease in opening lid 303. Lid 303 is attached to container 301 by a hinge on the top of the container as indicated at 305 on rear side 307 (not visible) of container 301 so as to be openable conveniently with one hand. Putty is stored inside container 301, where the painter may access it easily during painting. The inside surface of container 301 is chosen for the kind of putty to be stored, such as a soft putty as may be used during painting for repairing narrow cracks.

Front side 311 of putty container 301 has razor pocket 313 for holding a razor 315. Razor 315 is used to remove dried paint from windows. Razor pocket 313 allows one-hand access to razor 315 during painting. Front side 311 also has putty knife pocket 316 for holding scrapers or putty knives 317: putty knife pocket 316 allows putty knives 317 to be accessed with one hand. As shown in view 300 of embodiment 399, putty knife pocket 316 and razor pocket 313 are disposed laterally to each other on front side 311. Both razor 315 and putty knives 317 are selected to be of appropriate size, for example putty knives 317 are preferentially chosen for picking up putty from container 301—they may for example be chosen to be longer for a particular form of an embodiment such as 399.

The putty buddy may further include holders for various other tools employed during painting. Protrusions 323 and 325 on the sides of putty container 301 extend forward of front side 311 of container 301 and protect razor pocket 313 and putty knife pocket 316 from catching on other objects.

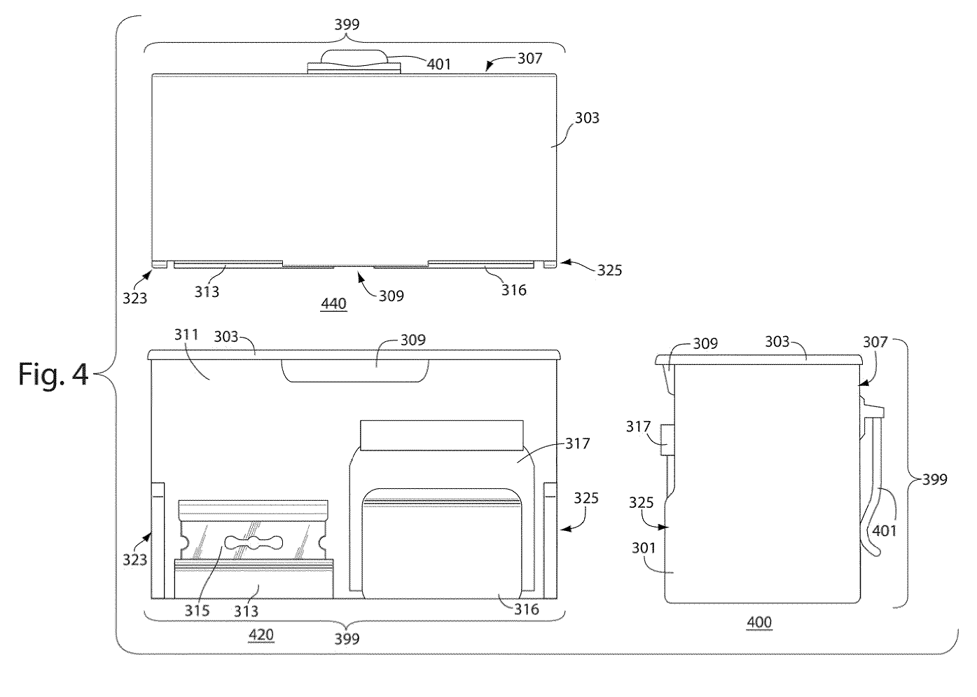

FIG. 4 shows additional views 400, 420 and 440 of embodiment 399. Side view 400 shows putty container 301 and putty knives 317 in putty knife pocket 316 (not visible). Clip 401 is shown on rear side 307 of putty container 301, for attaching embodiment 399 to the painter's work clothes or other convenient article.

Front view 420 of embodiment 399 shows putty container 301, lid 303 with lip extension 309, side guard protrusions 323 and 325, and front side 311. Also visible are razor pocket 313 with razor 315, and putty knife pocket 316 with putty knives 317.

Top view 440 of embodiment 399 shows top 303 with lip extension 309, razor pocket 313, and putty knife pocket 316. Also visible is clip 401 on rear side 307 of putty container 301.

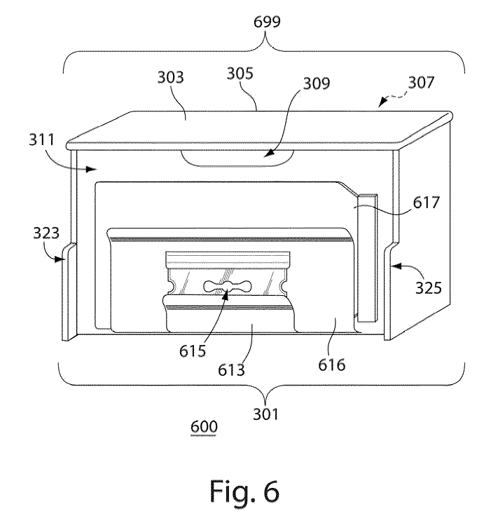

Oblique view 600 in FIG. 6 shows presently-preferred embodiment 699 of the putty buddy. Visible are container 301 with front side 311, lid 303 with lip extension 309, hinged attachment indicated at 305 on rear side 307 (not visible) of container 301, and protrusions 323 and 325.

Front side 311 of putty container 301 has razor pocket 613 for holding razor 615. Front side 311 also has putty knife pocket 616 for holding scrapers or putty knives 617: putty knife pocket 616 allows putty knives 617 to be accessed with one hand. As shown in view 600 of embodiment 699, putty knife pocket 616 is disposed centrally on front side 311, and razor pocket 613 is disposed centrally on putty knife pocket 616. For a given form of container 301 as illustrated, with particular dimensions, embodiment 699 allows for storage of longer putty knives 617 than does embodiment 399 for putty knives 317.

Conclusion

The foregoing Detailed Description has disclosed to those skilled in the technologies to which Applicant's techniques pertain how to make and use a tool for filling a hole in a surface and an apparatus for holding tools and material employed in preparing surfaces for painting. Applicant has further disclosed the best mode presently known to the inventor of making and using the tool and the apparatus according to his techniques. As will be immediately apparent to those skilled in the relevant technologies, countless other embodiments may be made according to the principles disclosed herein.

For example, the working surface of the hole filling tool may be attached to a finger by any mode of attachment according to the principles disclosed, including such exemplary modes as an adhesive, a rigid cylindrical form including exemplary shapes of a thimble, ring, or band, a flexible cylindrical form, or a finger part of glove. Modes may be employed that engage the fleshy part of the fingertip in a resilient fashion. The mode of attachment may further be adjustable in size. The working surface of the hole-filling tool may be made using any material or materials suitable for working a viscous filler material, and may be chosen according to the properties of a particular filler material. The working surface can of course be a surface of the mode of attachment, or may be distinct therefrom. The shapes of the filling portion and of the scraping portion of the working surface may be chosen to conform to any surface with a hole to be filled. Angles and dispositions of the working surface and attacher may be chosen to make the tool appropriate for the left or right hand or to adapt to the proportions of different users or fingers of a user.

The apparatus for holding tools and material employed in preparing surfaces for painting may employ a container of various shapes, dimensions, and number of sides. The holders for the razor and the knife may be of different forms than those shown in the exemplary embodiments and may be disposed on the same side of the container, or on different sides. The container may be adapted in its construction and/or form for a holding a particular kind of material, such as a soft filler material for filling cracks or a different material. The apparatus may include additional holder or holders to those shown, and may include a plurality of containers and/or a container may be partitioned. The apparatus may be attached to an article such as an article of working clothing by any kind of attachment such as an exemplary clip, snap, loop, button, tie, adhering surface such as Velcro®, and so forth.

For all of the foregoing reasons, the Detailed Description is to be regarded as being in all respects exemplary and not restrictive, and the breadth of the invention disclosed here in is to be determined not from the Detailed Description, but rather from the claims as interpreted with the full breadth permitted by the patent laws.

1. A tool for filling a hole in a surface,
the tool comprising:
a working surface; and
an attacher that attaches the working surface to a fingertip such that when the fingertip draws the working surface across the surface with the hole to be filled and over the hole, the working surface acts to force a viscous substance that has been deposited on the hole into the hole and/or to remove any of the viscous substance remaining on the surface with the hole to be filled from around the hole.

2. The tool set forth in claim 1
wherein:
the attacher does not hinder the motion of the fingertip.

3. The tool set forth in claim 1
wherein:
the working surface interacts resiliently with the fleshy part of the fingertip.

4. The tool set forth in claim 1
wherein:
the attacher defines a cylindrical form with at least one open end, whereby the tool is attached to the finger by inserting the fingertip into the open end.

5. The tool set forth in claim 4
wherein:
the cylindrical form is flexible

6. The tool set forth in claim 4
wherein:
the cylindrical form is rigid.

7. The tool set forth in claim 6
wherein:
the working surface is affixed to the rigid cylindrical form and disposed towards the tip of the fingertip relative to the cylindrical form.

8. The tool set forth in claim 7
wherein:
the rigid cylindrical form has an opening which permits compression and/or expansion of the cylindrical form's diameter.

9. The tool set forth in claim 7 wherein the working surface comprises:
a filling portion that forces the viscous substance into the hole, and
a scraping portion that removes viscous substance from the surface with the hole to be filled.

10. The tool set forth in claim 9
wherein:
the scraping portion is disposed towards the fingertip's tip relative to the filling portion.

11. The tool set forth in claim 10
wherein:
the working surface is further disposed relative to the cylindrical form at an angle towards the fingertip such that the working surface and the cylindrical form engage the fleshy part of the fingertip when the tool is in use, whereby the tool is prevented from coming off the finger.

12. The tool set forth in claim 10
wherein:
the working surface is disposed such that the corner of the working surface in the direction of the fingertip and on the side of the working surface towards the thumb of the hand is higher than the corner on the side opposite the thumb.

13. The tool set forth in claim 1
wherein the working surface comprises:
a filling portion that forces the viscous substance into the hole, and
a scraping portion that removes excess viscous substance from the surface with the hole to be filled.

14. The tool set forth in claim 13
wherein:
the scraping portion is disposed towards the fingertip's tip relative to the filling portion.

15. The tool set forth in claim 14
wherein:
the filling portion has a shape that conforms to the surface with the hole to be filled.

16. The tool set forth in claim 14
wherein:
the scraping portion a shape that conforms to the surface with the hole to be filled.

17. The tool set forth in claim 1
wherein:
the working surface is composed of a material that is adapted to performing the filling operation of claim 1 on the viscous material.

18. The tool set forth in claim 1
wherein:
the working surface is a surface of the attacher.

19. A tool for filling a hole in a surface
comprising:
a band and
a working surface,
the working surface being made of a stiff material, the band fitting on the fingertip of the finger above the fingertip joint,
the band further having a compressible/expandable opening,
the working surface further being affixed to the band towards the tip of the fingertip relative to the band, engaging the fleshy part of the finger tip, being angled towards the fleshy part of the fingertip, having a filling portion and a scraping portion, the filling portion having a shape that conforms to the surface with the hole to be filled and the scraping portion being an edge of the filling portion which is disposed towards the tip of the fingertip, having a shape that conforms to the surface with the hole to be filled, and being angled relative to the working surface such that working surface's corner on the side towards the thumb of the hand extends in the direction away from the finger further than the corner of the working surface on the side opposite the thumb.

20. An apparatus for holding tools and material employed in preparing surfaces for painting,
the apparatus comprising:
a container for the material, the container having a plurality of sides including an attacher side which includes an attacher for attaching the container to an article of clothing worn by a user of the apparatus, a bottom, and a top that is openable with one hand when the container is attached to the article of clothing;
a first holder for holding a razor blade, the first holder being disposed on a side of the plurality of sides other than the attacher side, and
a second holder for holding a knife for working the material, the second holder being disposed on a side of the plurality of sides other than the attacher side, the knife and the razor blade being accessible with one hand, and
a protrusion which keeps the first and/or second holder from catching on objects.
